(19) United States
(12) Patent Application Publication
(10) Pub. No.: US 2006/0048385 A1
(43) Pub. Date: Mar. 9, 2006

(54) Minimized profile circuit module systems and methods

(75) Inventors: James W. Cady, Austin, TX (US); James Douglas Wehrly JR., Austin, TX (US); Paul Goodwin, Austin, TX (US)

Correspondence Address: J. SCOTT DENKO, ANDREWS & KURTH LLP, 111 CONGRESS AVE., SUITE 1700, AUSTIN, TX, 78701, US

(73) Assignee: Staktek Group L.P.

(21) Appl. No.: 11/242,962

(22) Filed: Oct. 4, 2005

Related U.S. Application Data
(63) Continuation-in-part of application No. PCT/US05/28547, filed on Aug. 10, 2005.
(63) Continuation-in-part of application No. 11/005,992, filed on Dec. 7, 2004.
Application No. 11/005,992 is a continuation-in-part of application No. 10/934,027, filed on Sep. 3, 2004.

(51) Int. Cl. H01R 43/02

(52) U.S. Cl. 29/860; 29/832

(57) ABSTRACT

Flexible circuitry is populated on one or both sides with integrated circuits (ICs) each of which ICs has an IC profile (height). A substantially flat, windowed fixture with a fixture profile less than the IC profiles of the ICs is applied over an IC-populated side of the flexible circuitry causing at least a part of the ICs to emerge from respective fixture windows. Material is removed simultaneously from that portion of the ICs that emerge from the windows to result in lower-profile ICs which, in a preferred embodiment exhibit profiles substantially coincident with the fixture profile established by the upper surface of the fixture. The method is used to advantage in devising circuit modules by disposing the flexible circuitry about a rigid substrate to form the circuit module with a low profile. Some embodiments use substrates that are windowed or have inset areas into which the lower profile CSPs may be set to reach profile requirements.

### RELATED APPLICATIONS

This application is a continuation-in-part of Pat. App. No. PCT/US05/28547 filed Aug. 10, 2005, pending, and a continuation-in-part of U.S. Pat. App. No. 11/005,992 filed Dec. 7, 2004, pending, which application is a continuation-in-part of U.S. patent application Ser. No. 10/934,027 filed Sep. 3, 2004, pending.

U.S. patent application Ser. No. 10/934,027 filed Sep. 3, 2004; U.S. Pat. App. No. 11/005,992 filed Dec. 7, 2004; U.S. Pat. App. No. 11/007,551 filed Dec. 8, 2004; U.S. Pat. App. No. 11/068,688 filed Mar. 1, 2005; U.S. Pat. App. No. 11/123,721 filed May 6, 2005; U.S. Pat. App. No. 11/125,018 filed May 9, 2005; U.S. Pat. App. No. 11/193,954 filed Jul. 29, 2005; and Pat. App. No. PCT/US05/28547 filed Aug. 10, 2005 are each hereby incorporated by reference herein.

### FIELD

The present invention relates to systems and methods for creating high density circuit modules and, in particular, to systems and methods for producing such modules with low profiles.

### BACKGROUND

Memory expansion is one of the many fields where high density circuit module solutions provide space-saving advantages. For example, the well-known DIMM (Dual In-line Memory Module) has been used for years, in various forms, to provide memory expansion. A typical DIMM includes a conventional PCB (printed circuit board) with memory devices and supporting digital logic devices mounted on both sides. The DIMM is typically mounted in the host computer system by inserting a contact-bearing edge of the DIMM into a card edge connector. Typically, systems that employ DIMMs provide limited profile space for such devices and conventional DIMM-based solutions have typically provided only a moderate amount of memory expansion.

There are several known methods to improve the limited capacity of a DIMM or other circuit board. Many of these techniques result in less than optimum profiles for the resulting circuit modules. For example, in one strategy, small circuit boards (daughter cards) are connected to the DIMM to provide extra mounting space. The additional connection may, however, cause flawed signal integrity for the data signals passing from the DIMM to the daughter card while the additional thickness of the daughter card(s) increases the profile of the module.

Multiple die packages (MDP) can also be used to increase DIMM capacity. This scheme increases the capacity of the memory devices on the DIMM by including multiple semiconductor die in a single device package. The additional heat generated by the multiple die typically requires, however, additional cooling capabilities to operate at maximum operating speed. Further, the MDP scheme may exhibit increased costs because of increased yield loss from packaging together multiple die that are not fully pre-tested.

Staktek Group LP has developed numerous systems for aggregating CSP and other IC devices in space-saving topologies and circuit modules of high capacity. Some of these techniques employ flexible circuitry to produce low profile stacks or larger capacity circuit modules that may supplant traditional DIMMs. Some capacity-enhancing techniques may, however, result in modules that approach or exceed system profile requirements such as, for example, minimum spacing around a circuit module on its host system in applications such as, for example, SO-DIMM or compact flash card applications. What is needed, therefore, are methods and systems for providing high capacity circuit modules in thermally-efficient, reliable designs that can be made at reasonable cost while exhibiting reduced profiles.

### SUMMARY

Flexible circuitry is populated on one or both sides with integrated circuits (ICs) each of which ICs has an IC profile (height). A substantially flat, windowed fixture with a fixture profile less than the IC profiles of the ICs is applied over an IC-populated side of the flexible circuitry causing at least a part of the ICs to emerge from respective fixture windows. Material is removed simultaneously from that portion of the ICs that emerge from the windows to result in lower-profile ICs which, in a preferred embodiment exhibit profiles substantially coincident with the fixture profile established by the upper surface of the fixture. The method is used to advantage in devising circuit modules by disposing the flexible circuitry about a rigid substrate to form the circuit module with a low profile. Some embodiments use substrates that are windowed or have inset areas into which the lower profile CSPs may be set to reach profile requirements.

### BRIEF DESCRIPTION OF THE DRAWINGS

FIG. 1 depicts one side of a flex circuit populated with ICs.

FIG. 2 depicts another side of the flex circuit depicted in FIG. 1.

FIG. 3 depicts an exemplar IC that may be employed in accordance with some embodiments of the invention.

FIG. 4 is a cross-sectional depiction of the IC-populated flex circuit of FIGS. 1 and 2 taken along the line A-A shown in FIG. 1.

FIG. 5 depicts a fixture devised in accordance with a preferred embodiment of the present invention.

FIG. 6 depicts an exploded view of a fixture and IC populated flex circuit in accordance with a preferred embodiment of the present invention.

FIG. 7 depicts a fixture applied to an IC-populated flex circuit in accordance with the present invention.

FIG. 7 depicts a process in accordance with a preferred embodiment of the present invention.

FIG. 8 depicts a circuit module devised in accordance with an embodiment of the present invention.

FIG. 9 depicts a circuit module devised in accordance with an embodiment of the present invention.

### DETAILED DESCRIPTION OF PREFERRED EMBODIMENTS

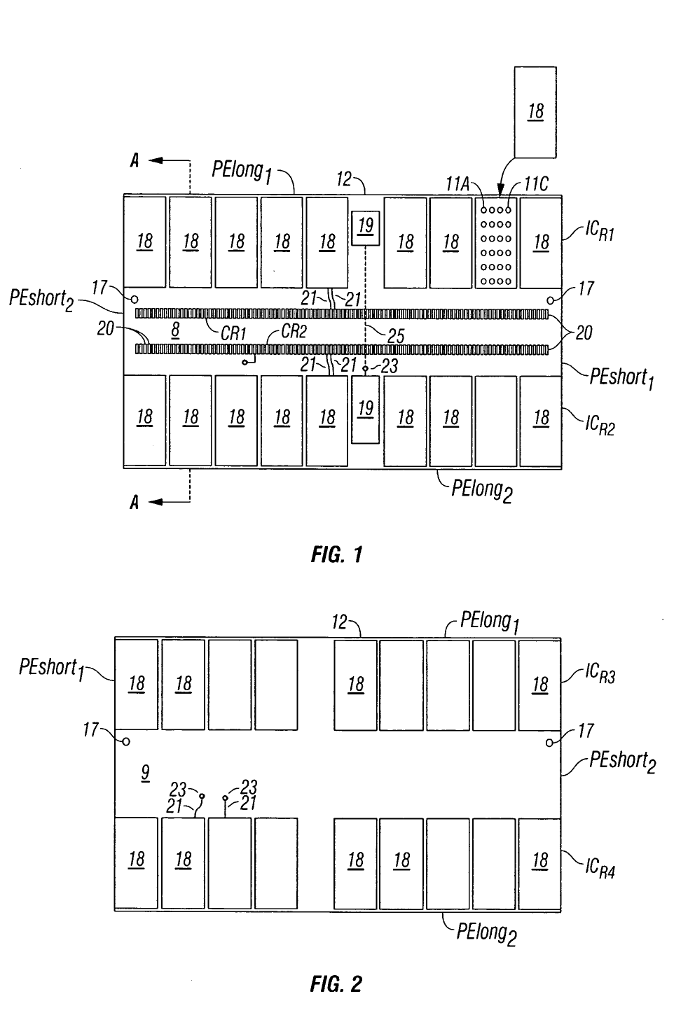

FIG. 1 depicts a first side 8 of flex circuit 12 (“flex”, “flex circuitry”, “flexible circuit”) used in constructing a module according to an embodiment of the present invention. Flex circuit 12 is preferably made from one or more conductive layers supported by one or more flexible substrate layers. The entirety of the flex circuit 12 may be flexible or, as those of skill in the art will recognize, the flexible circuit structure 12 may be made flexible in certain areas to allow conformability to required shapes or bends, and rigid in other areas to provide rigid and planar mounting surfaces. Flex circuit 12 has openings 17 for use in aligning flex circuit 12 to substrate 14 during assembly.

ICs 18 attached to flexible circuit 12 are, in this embodiment, chip-scale packaged memory devices of small scale. For purposes of this disclosure, the term chip-scale or “CSP” shall refer to integrated circuitry of any function with an array package providing connection to one or more die through contacts (often embodied as “bumps” or “balls” for example) distributed across a major surface of the package or die. CSP does not refer to leaded devices that provide connection to an integrated circuit within the package through leads emergent from at least one side of the periphery of the package such as, for example, a TSOP.

The present invention may be employed with and to create modules that are populated with leaded or CSP devices or other devices with planar upper surfaces but where the term CSP is used, the above definition for CSP should be adopted. As those of skill will understand after appreciating this disclosure, some embodiments of the present invention may be employed to reduce the profile of stacks or modules and that the depictions of FIGS. 1 and 2 are directed merely to a prefatory step in creating an exemplar circuit module that is merely one of many configurations of modules that may be devised in accordance with the present invention.

Multiple integrated circuit die may be included in a package depicted as a single IC 18. While in this embodiment memory ICs are used to provide a memory expansion board or module, various embodiments may include a variety of integrated circuits and other components. Such variety may include microprocessors, FPGA's, RF transceiver circuitry, digital logic, as a list of non-limiting examples, or other circuits or systems which may benefit from a high-density circuit board or module capability of thin profile. In some preferred embodiments, circuit 19 may be considered to be an AMB, but the principles of the invention may be employed with modules populated with a variety of devices in addition to or such as, for example, a microprocessor or graphics processor employed in a circuit module.

The depiction of FIG. 1 shows flex circuit 12 as having first and second fields, ranks or pluralities of ICs 18 with one on each side of contacts 20. Those of skill will recognize that contacts 20 may appear on one or both sides of a module that employs flexible circuit 12 depending on the mechanical contact interface particulars of the application.

Flex circuit 12 may also referenced by its perimeter edges, two of which are typically long (PE_{long1} and PE_{long 2}) and two of which are typically shorter (PEₛₕₒᵣₜ₁ and PEₛₕₒᵣₜ₂) although flex circuit 12 may come in a variety of shapes including square. Contact arrays such as array 11A are disposed beneath ICs 18 and circuit 19 and are comprised of array contacts 11C. An exemplar contact array 11A is shown as is exemplar IC 18 to be mounted at contact array 11A as depicted.

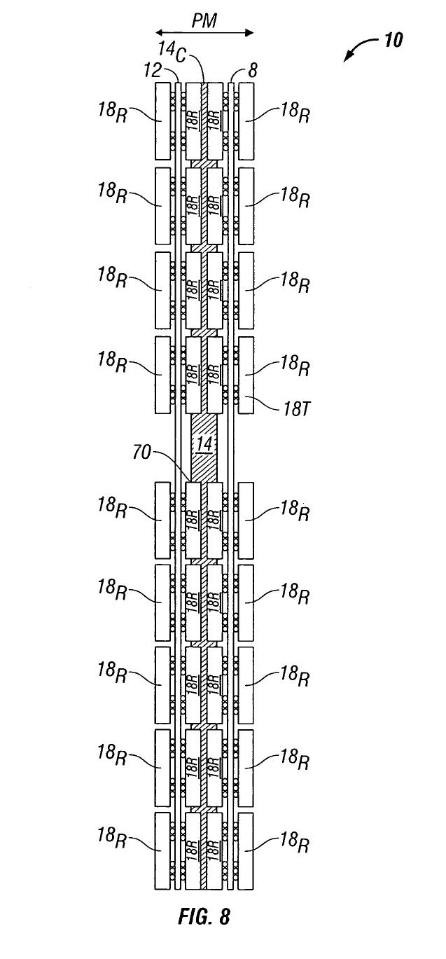

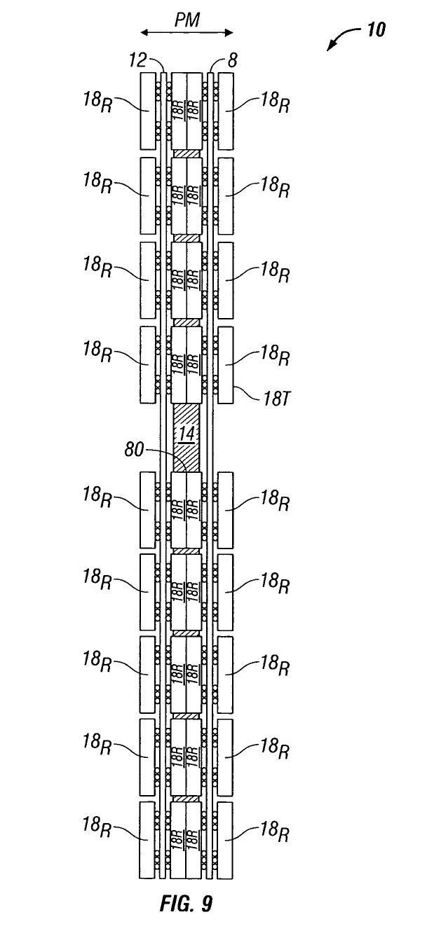

A first plurality of ICs 18 is shown on side 8 of flex circuit 12 and is identified as IC_{R1} and a second plurality of CSPs is identified as IC_{R2}. Those of skill will recognize that the identified pluralities of CSPs are, when disposed in the configurations depicted, typically described as “ranks”. Between the ranks IC_{R1} and IC_{R2}, flex circuit 12 bears a plurality of module contacts allocated in this embodiment into two rows (C_{R1} and C_{R2}) of module contacts 20. When flex circuit 12 is folded about substrate 14 as depicted in, for example, later FIGS. 8 and 9, side 8 depicted in FIG. 1 is presented at the outside of module 10. The opposing side 9 of flex circuit 12 is on the inside of module 10 and thus for modules such as that depicted in FIG. 8, side 9 is closer to the substrate 14 about which flex circuit 12 is disposed than is side 8. Other embodiments may have other numbers of ranks and combinations of plural CSPs connected to create the module of the present invention.

FIG. 1 depicts an exemplar conductive trace 21 connecting row C_{R2} of module contacts 20 to ICs 18. Those of skill will understand that there are many such traces in a typical embodiment. Traces 21 may also connect to vias that may transit to other conductive layers of flex 12 in certain embodiments having more than one conductive layer. In a preferred embodiment, vias connect ICs 18 on side 9 of flex 12 to module contacts 20. An example via is shown as reference 23. Traces 21 may make other connections between the ICs on either side of flex 12 and may traverse the rows of module contacts 20 to interconnect ICs. Together the various traces and vias make interconnections needed to convey data and control signals amongst the various ICs and buffer circuits.

FIG. 2 shows side 9 of flex circuit 12 depicting the other side of the flex circuit shown in FIG. 1. Side 9 of flex circuit 12 is shown as being populated with multiple CSPs 18 although it may also bear other circuits such as, for example, a circuit 19 which in one general type of embodiment may be an AMB. The ICs shown in these depictions are typically attached to the flexible circuit with solder.

As those of skill recognize, to meet standardized application specifications, typical circuit modules must meet published specifications for, amongst other requirements, cross-sectional thickness or “profile” as it is sometimes called. One specification for circuit module profile that is particularly stringent is set by JEDEC in its outline for SO-DIMMs. Such DIMMs are commonly employed in laptop computers where space and weight are driving considerations. The JEDEC SO-DIMM specification for cross-sectional profile is currently 3.85 mm. Typical DRAM memory CSPs are commonly produced with profiles of 1.2 or 1.0 mm. Consequently, if a circuit module is produced with even the thinner CSP with a CSP profile (height) of 1.0 mm, if the CSPs are aggregated four CSPs across, the module will not meet the 3.85 mm specification. There are known methods to lap ICs to produce thinner devices but individual IC thinning typically results in a variety of problematic issues such as curling of the IC (camber) and expense.

The assignee of the present application, Staktek Group LP, has devised many configurations for high density circuit modules and stacks. In some of the higher capacity module configurations, the populated flex circuit of FIGS. 1 and 2 is wrapped about a rigid substrate resulting in a high capacity circuit module with two layers of ICs on each lateral side of the module. Thus, when typical ICs 18 and substrates that are windowed as taught in copending patent application U.S. Pat. App. No. 11/005,992 filed Dec. 7, 2004 are employed with a populated flex circuit 12 such as depicted in FIGS. 1 and 2, the resulting circuit module has a profile “PM” of either 5.2 mm or 4.4 mm, respectively, using 1.2 mm and 1.0 mm FBGA packaged DRAMs as ICs 18. Consequently, the 3.85 mm requirement for SO-DIMMs is not quite achieved with ICs 18 having profiles of 1.2 mm or 1.0 mm when the high density solution disclosed in U.S. Pat. App. No. 11/005,992 filed Dec. 7, 2004 which is incorporated by reference herein, is employed. Many other configurations of low profile are achieved by the modules disclosed in that application, but for the particular SO-DIMM application discussed above, as well as those applications where the lowest profile with high density is of high utility, the present invention provides significant advantages.

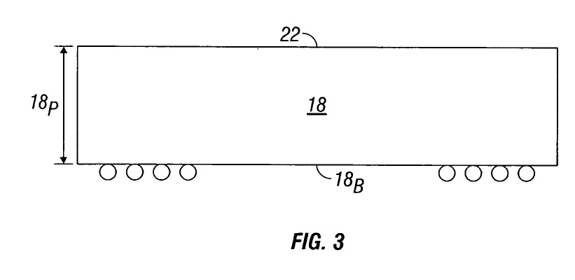

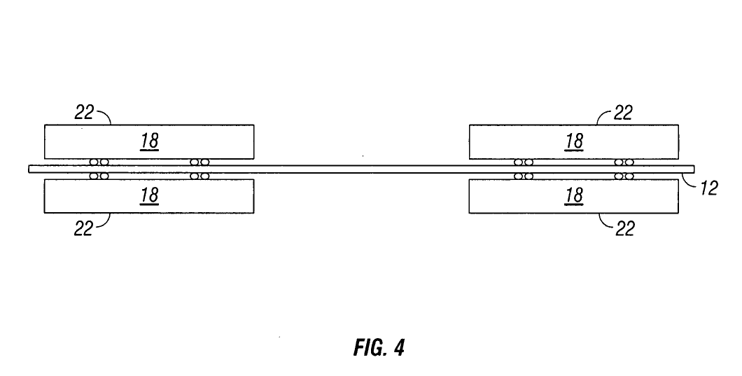

FIG. 3 depicts a typical IC 18 as may be employed in accordance with some embodiments of the present invention. IC 18 is a CSP with upper surface 22 and bottom surface 18_{B}. It has a profile height indicated by reference 18_{P}.

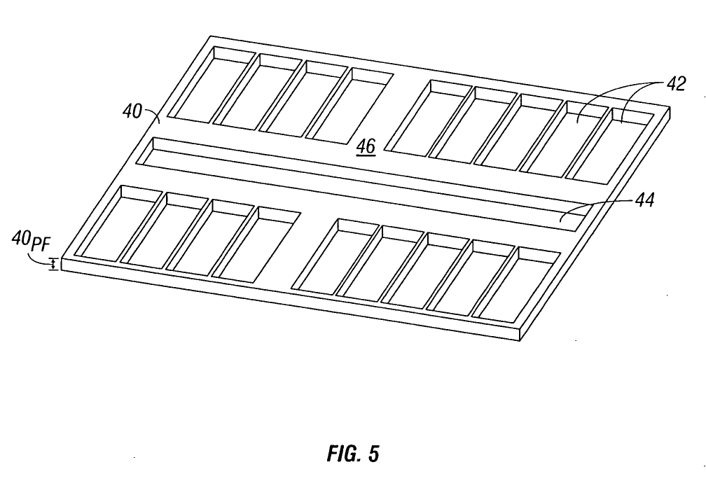

FIG. 4 is a cross-sectional depiction of flex circuit 12 taken along the line A-A shown in earlier FIG. 1.

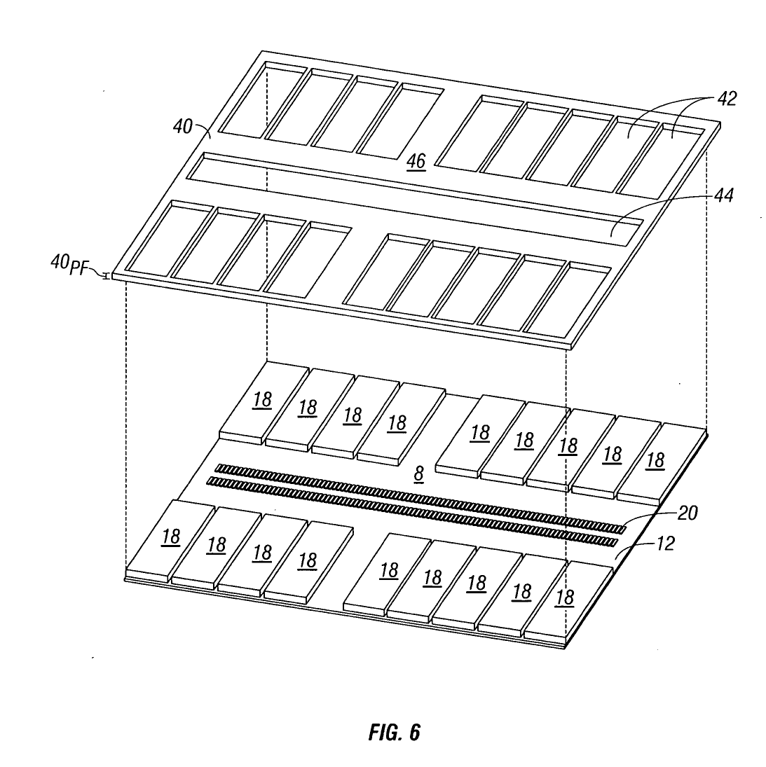

FIG. 5 illustrates an exemplar fixture 40 in accordance with an embodiment of the present invention. Fixture 40 exhibits holes 42 dimensioned to fit about ICs 18 and slot 44 to fit over the area about contacts 20 of flex circuit 12 shown in FIG. 1. Upper surface of fixture 40 is identified by reference 46 and fixture 40 has a thickness or profile identified by 40_{PF}.

In a preferred embodiment, fixture 40 is comprised from a hard material that exhibits a high degree of wear resistance and hardness. Metals are typical appropriate materials for fixture 40 and example preferred materials would be comprised of high chromium content (corrosion resistant) tool steel, with good to excellent wear resistance, hardened to Rc 55-62 (Rc=Rockwell hardness scale C) for maximum life of fixture 40. Some particular examples include, but certainly are not limited to, cold work die steels such as D2 or D7 Tool steels or hot work die steels such as H23 Tool steel. After appreciating this disclosure, those of skill will recognize other candidate and some non-metallic materials as well may be employed to advantage in embodiments of the present invention.

FIG. 6 is an exploded depiction of fixture 40 being disposed over IC-populated flex circuit 12. Fixture 40 allows substantially simultaneous and uniform removal of material from ICs 18 (or other ICs populated upon flex circuitry 12) to reduce the profile of the subject IC.

In contrast to individual IC lapping, camber forces that could be introduced by the material removal process are inhibited by the flex circuit 12 substrate to which the ICs being processed are attached prior to the material removal. Those of skill will appreciate that fixtures other than those depicted in FIGS. 5 and 6 may be employed in preferred methods of the present invention. For example, a fixture having fewer holes 42 may be employed or only ICs on parts of populated flex circuit 12 may be processed by the methods of the present invention and other configurations of IC-populated flex circuits may be employed in accordance with the present invention.

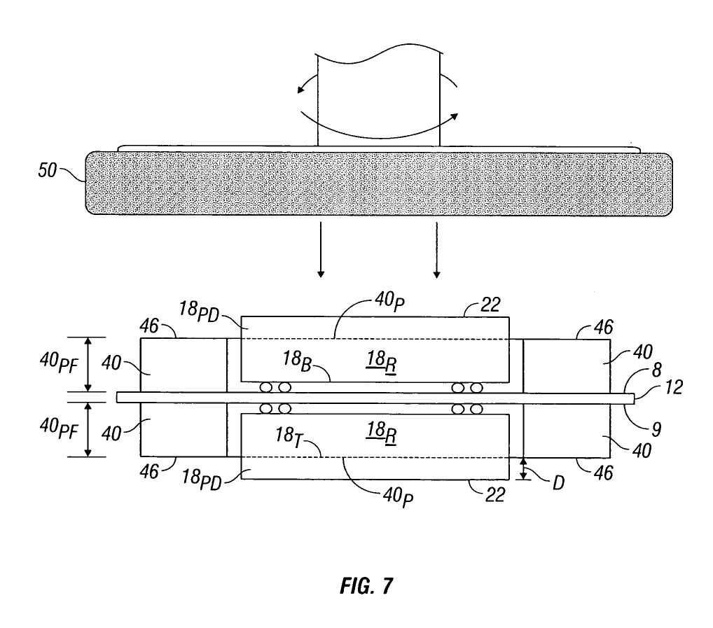

FIG. 7 illustrates a process in accordance with a preferred embodiment of the present invention. With reference to FIG. 7, those of skill will note that the indicated profile 40_{PF} of exemplar fixture 40 is less than the IC profile 18_{P} of exemplar IC 18. Lapping machine 50 effectuates removal of material from that portion of IC 18 emergent from fixture window IC 18 to reduce the IC profile of IC 18 by the amount indicated by D on FIG. 7 to be substantially coincident with a plane “40_{P}” established by upper surface 46 of fixture 40. Thus, in this embodiment, the fixture provides a “lap—to” surface and the resulting profile of reduced IC 18R will preferably substantially equal:
(IC profile 18_{P})−D=Profile of IC 18R (or 18_{RP}). (1)
Thus, preferably, fixture profile 40_{PF} will be substantially equal to reduced IC 18_{R} profile 18_{RP}. The material removed from IC 18 is indicated by the reference 18_{PD} and the remaining now thinned IC 18 is indicated by 18_{R}. Reduced IC 18_{R} will have the same bottom surface 18_{B} that existed when IC 18_{R} was IC 18 but the device will have a new top surface 18_{T} rather than upper surface 22. In the depicted embodiment, the process of removing material from the ICs 18 may be characterized as lowering the profile of ICs 18. Removing material from ICs 18 is done to at least more than one IC 18 at a time. This gains efficiency from the affixation of the subject ICs to flex circuit 12. Those of skill will recognize that a variety of tools may be employed to effectuate the removal of material from the portion of ICs 18 emergent from the windows of fixture 40 in addition to or other than the lapping tool represented by reference 50 and that the process of removing material from ICs 18 may include particular techniques such as the following non-limiting examples, thinning, polishing, abrading, cutting, shaving, planning, or lapping, for example.

FIG. 8 depicts an exemplar module 10 devised in accordance with embodiments of the present invention. The view of FIG. 8 is a cross-section of an exemplar module 10 devised to advantage by use of the methods disclosed herein. The exemplar rigid substrate 14 employed in the depicted module 10 exhibits insert areas 70 into which may be disposed thinned ICs 18_{R} as flex circuit 12 is wrapped about an edge of substrate 14. This places selected ICs 18_{R} in back to back juxtaposition between which are portions of substrate 14 (14_{C}) to assist in thermal performance. The profile PM of module 10 is less than it would have been had typical ICs 18 of profile 18_{P} been employed rather than thinned ICs 18_{R} with profile 18_{RP}.

FIG. 9 depicts another exemplar module 10 devised in accordance with a preferred embodiment of the present invention. As shown, substrate 14 exhibits windows 80 all the way through substrate 14 in areas where ICs 18_{R} are inset to be juxtaposed back to back including either directly or through a glue or adhesive, for example. In the particular exemplar case of creating a circuit module that meets the JEDEC SO-DIMM specification, those of skill will recognize that if 0.34 mm or 0.14 mm of material is removed (i.e., corresponding to portion 18_{PD} of IC 18 as identified in FIG. 7) a module 10 may be devised that meets the JEDEC specification for profile for an SO-DIMM. Thus a module 10 as shown in FIG. 9, may be devised with use of the present methods disclosed herein to result in a double density circuit module of 3.85 mm profile.

It will be apparent to those skilled in the art that many embodiments taking a variety of specific forms and reflecting changes, substitutions and alterations can be made without departing from the spirit and scope of the invention. Therefore, the described embodiments illustrate but do not restrict the scope of the claims.

1. A method for reducing the profile of more than one IC at a time, the method comprising the steps of:
attaching to a flexible circuit, plural ICs each of which has an IC profile;
providing a fixture having an upper surface and through which fixture plural holes are exhibited, the fixture having a fixture profile that is less than the IC profile;
setting the fixture over the flexible circuit so that a portion of each of the plural ICs rises above the upper surface of the fixture;
removing material substantially simultaneously from the portion of each of the plural ICs that rises above the upper surface of the fixture.

2. The method of claim 1 in which the step of removing material substantially simultaneously from the portion of each of the plural ICs that rises above the upper surface of the fixture is realized by lapping.

3. The method of claim 1 in which the step of removing material substantially simultaneously from the portion of each of the plural ICs that rises above the upper surface of the fixture is realized by polishing.

4. The method of claim 1 in which the step of removing material substantially simultaneously from the portion of each of the plural ICs that rises above the upper surface of the fixture results in the plural ICs each having a reduced profile that is substantially equal to the fixture profile.

5. The method of claim 1 in which the step of removing material substantially simultaneously from the portion of each of the plural ICs that rises above the upper surface of the fixture results in a top surface for each of the plural ICs that is substantially coincident with a plane established by the upper surface of the fixture.

6. The method of claim 1 in which the fixture is comprised of metallic material.

7. The method of claim 1 in which the plural ICs are comprised of a first plurality of ICs attached to a first surface of the flexible circuit and a second plurality of ICs attached to a second surface of the flexible circuit.

8. The method of claim 1 in which the flexible circuit has contacts devised to connect the plural ICs to an application environment and the fixture has a slot sized to fit over the contacts.

9. The method of claim 1 in which the fixture is comprised of hardened metallic material that includes chromium.

10. The method of claim 4 in which the fixture is comprised of metallic material that has a hardness of between 52 Rc and 55 Rc inclusive on the Rockwell hardness scale.

11. The method of claim 1 in which the plural ICs are CSP memory devices.

12. A method for reducing the profile of more than on IC at a time, the ICs to be employed together in a circuit module, the method comprising the steps of:
soldering more than one CSP to a flexible circuit, each of the CSPs having an IC profile;
placing a fixture having an upper surface and plural holes and having a fixture profile that is smaller than the IC profile over the flexible circuit so that individual ones of the CSPs emerge in part from individual ones of the plural holes; and
removing material from the portion of each of the CSPs that emerge from the plural holes to result in more than one CSP with a top surface that is substantially coincident with a plane defined by the upper surface of the fixture.

13. The method of claim 12 in which the fixture is comprised of hardened metallic material.

14. A circuit module devised by use of the method of claim 12.

15. A circuit module devised by use of the method of claim 1.

16. A method for making a circuit module comprising the steps of:
populating a flexible circuit with plural CSPs by attaching each of the plural CSPs to the flexible circuit, each of the plural CSPs having an IC profile;
placing a fixture over the populated flexible circuit, the fixture having an upper surface above which emerge portions of each of the plural CSPs; and
removing material from the plural CSPs simultaneously; and
disposing the populated flexible circuit about a rigid substrate.

17. The method of claim 16 in which the rigid substrate has plural windows into which are placed selected ones of the plural CSPs oriented in back toward back juxtaposition.

18. The method of claim 16 in which the rigid substrate has plural insets into which are placed selected ones of the plural CSPs in back toward back juxtaposition separated by a portion of the rigid substrate.

19. The method of claim 16 in which the fixture has a slot that fits over a set of contacts disposed along the flexible circuit.

20. The method of claim 16 in which the fixture is comprised of tool steel that is hardened to a hardness of Rc 55 to Rc 62 inclusive on the Rockwell hardness scale.

21. The method of claim 20 in which the fixture is comprised of D2 or D7 tool steel.

22. The method of claim 20 in which the fixture is comprised of hot work H23 Tool steel.

23. The method of claim 16 in which the step of removing material is implemented with lapping.

24. The method of claim 16 in which the step of removing material is implemented with polishing.

25. The method of claim 16 in which the circuit module exhibits a module profile of less than or equal to 3.85 mm.

26. The method of claim 25 in which the plural CSPs are memory devices.

27. The method of claim 16 in which the rigid substrate is comprised of thermally conductive material.

28. The method of claim 16 in which the rigid substrate is comprised of aluminum.

29. The method of claim 16 in which the circuit module is an implementation of a fully-buffered DIMM.
